(19) United States
(12) Patent Application Publication
(10) Pub. No.: US 2025/0055933 A1
(43) Pub. Date: Feb. 13, 2025

(54) Cell Phone Corner Cover Device

(71) Applicant: Catherine Nadolsky, Cresson, PA (US)

(72) Inventor: Catherine Nadolsky, Cresson, PA (US)

(21) Appl. No.: 18/786,044

(22) Filed: Jul. 26, 2024

Related U.S. Application Data
(60) Provisional application No. 63/518,010, filed on Aug. 7, 2023.

(51) Int. Cl. H04M 1/03

(52) U.S. Cl. CPC H04M 1/03

(57) ABSTRACT

A cell phone corner cover device is provided. The device is comprised of a slip cover body, at least one channel with at least one fastener, and an exterior with at least one grip area. The device is a corner cover that reduces hand fatigue along with relieving finger pain while holding a handheld device. Additionally, the cell phone corner cover device also provides a layer of protection for the handheld device.

### CROSS-REFERENCE TO RELATED APPLICATION

The present application claims priority to, and the benefit of, U.S. Provisional Application No. 63/518,010, which was filed on Aug. 7, 2023, and is incorporated herein by reference in its entirety.

### FIELD OF THE INVENTION

The present invention relates generally to the field of cell phones. More specifically, the present invention relates to a cell phone corners cover device, tablet, hand held tablets, Nooks, Kindles or familiar device as well as covering for Pop socket type cover that can be attached to a cell phone to reduce hand fatigue along with relieving finger pain while holding a handheld device. Accordingly, the present disclosure makes specific reference thereto. Nonetheless, it is to be appreciated that aspects of the present invention are also equally applicable to other like applications, devices, and methods of manufacture.

### BACKGROUND

Many individuals hold cell phones or tablets for extended periods of time. During these extended periods of time, individuals can develop significant hand fatigue and finger pain. As a result, an individual may want a convenient tool to provide relief during these extended periods of time. Not just for pain relief but also as a fun way to customize, trendy cell phone slip to fit over thin cell phone cases, as well as handheld tablet and finger extenders holders such as pop sockets. While holding these devices, it can become difficult to complete tasks in one extended period or complete several tasks and the same time. With a covering tool that provides enough relief in the user's hand or finger, individuals can complete several tasks comfortably.

Moreover, the consequences of hand fatigue and finger pain cannot continue without creating long-lasting health problems for the user. More alarmingly, individuals who experience continuous stiffness, numbness, tingling, or fatigue from handheld devices may develop long-lasting health conditions including carpel tunnel. This can lead not only to discomfort and pain for individuals but can also lead to additional healthcare costs for individuals. By providing a tool that holds the handheld device in a functional manner, a user can avoid the pain caused by these conditions.

However, existing handheld covers known in the art do not provide additional means of reliving hand fatigue or finger pain. These covers are focused on protecting the handheld device itself, not the user. This is undesirable, as in some instances, hand fatigue is developed. In addition, corner covers may be used to allow individuals to complete multiple tasks in one time period. Lastly, the user may use the corner cover for personalization options to differentiate between several handheld devices.

Therefore, there exists a long-felt need in the art for a device that can be applied to the corners of a smart device. More specifically, there exists a long-felt need in the art for a handheld device corner cover device that can be applied to various cellphones, tablets, or other smart devices to reduce hand fatigue along with hand or finger pain while providing a layer of protection for the handheld device. Furthermore, there exists a long-felt need in the art for a cell phone corner cover device that is personalized for differentiation between various handheld devices.

The subject matter disclosed and claimed herein, in one embodiment thereof, comprises a cell phone corner cover device. The device is comprised of a body comprised of a channel and a fastener. The body may have a channel in which a handheld device is supported along with a fastener to secure the handheld device to the device. The exterior may include a grip area, preferably made from a rubber, silicone, gel, foam, or textured material such as velvet, silk, etc., to ensure the device does not slip from the desired location.

In this manner, the cell phone corner cover device of the present invention accomplishes all the foregoing objectives and provides a device that easily supports handheld smart devices while in use. More specifically, the cell phone corner cover device can relieve handheld device users from hand fatigue along with hand or finger pain preventing various health conditions. Further, the cell phone corner cover provides an additional layer of protection for the handheld device Lastly, the cell phone corner device provides personalized differentiation between several devices through various indicia.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cell phone corner cover device comprised of a body, containing a channel and fastener, along with an exterior body, preferably made from a durable and sturdy material, with various indicia. The device is designed to provide optimal comfort and support to the user's hand and finger while using handheld devices for extended periods of time.

The body is preferably from a plastic or rubber material that provides durability and sturdiness while using the handheld device. The body preferably has a channel to secure the placement of the handheld device corners. In one embodiment, the channel also comprises a fastener to secure the handheld device into place. This will prevent the device from becoming detached from the handheld device.

Further, the body comprises an exterior. In one embodiment, the exterior is comprised of a flexible gel material, silicone, rubber, foam, clastic that relieves hand pressure while holding a cell phone or tablet for an extended period. In another embodiment, the exterior is comprised of a foam or cushion material for additional comfort. Additionally, the exterior allows the device to be placed on a flat surface. Lastly, the exterior provides an additional layer of protection around the handheld device. The exterior also comprises a grip area.

The grip area is preferably embossed into the device. In another embodiment, the grip area is made from a foam or gel material built into the device. Further, the grip area allows the user to maintain a firm grasp on the device. Moreover, the grip area provides additional relief to the user's hand and finger pain or fatigue.

The present invention is also comprised of a method of using the device. First, a device is provided comprised of a body, containing a channel and fastener, along with an exterior body comprising a grip area. Easily removable, durable, cell phone, tablet, finger holders. Then, a user can slide the handheld device into the channel of the device. Next, a user will insert the opposite corner of the device into the opposing channel of the device. A user may secure the device using at least one fastener. Finally, a user will grip the device in their hand for long-lasting comfort while using the handheld device.

Accordingly, the cell phone corner cover device of the present invention is particularly advantageous as it provides users with additional support and comfort while using handheld smart devices over a prolonged period. More specifically, it prevents users from developing health conditions related to strenuous hand and figure use. Furthermore, the device prevents strenuous use of the hand and finger muscles through the comforting gel material and grip area. Additionally, the cell phone corner cover device provides a layer of protection around the edge of the cell phone or tablet. Lastly, the device enables users to differentiate between several devices through personalized indicia. In this manner, the cell phone corner cover device overcomes the limitations of existing headstones known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a cell phone corner cover device of the present invention in accordance with the disclosed architecture;

FIG. 2 illustrates a perspective view of one potential embodiment of a cell phone corner cover device of the present invention while attached to a cell phone in accordance with the disclosed architecture; and

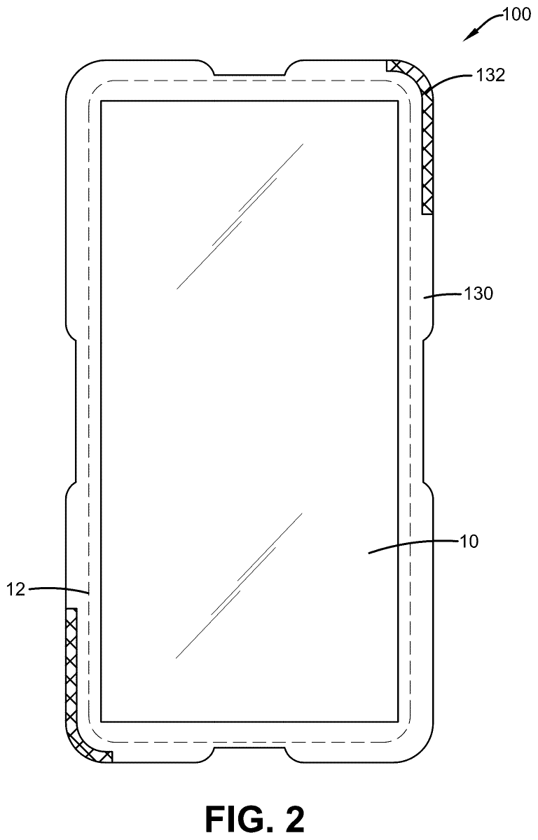

FIG. 3 illustrates a flowchart of a method of using one potential embodiment of a cell phone corner cover device of the present invention in accordance with the disclosed architecture.

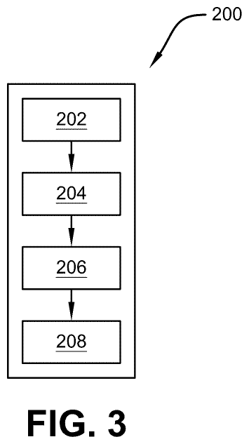

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a device that can be applied to the corners of a handheld smart device. More specifically, there exists a long-felt need in the art for a handheld device corner cover device that can be applied to various cellphones or tablets to reduce hand fatigue along with hand or finger pain while providing a layer of protection for the handheld device. Furthermore, there exists a long-felt need in the art for a cell phone corner cover device that is personalized for differentiation between various handheld devices.

The present invention, in one exemplary embodiment, is comprised of a cell phone corner cover device. The device is comprised of a body, preferably made from a rubber and durable material, comprising of at least one channel with at least one fastener, and an exterior, comprising of at least one grip area with at least one variety of indicia.

The body is preferably made from a rubber material that provides durability and comfort to the user's hands or fingers. Additionally, the body provides bumper protection around the edges of the cell phone or tablet, and comprises at least one channel. The at least one channel is used to place the device on the desired handheld piece of technology. In one embodiment, at least one channel comprises at least one fastener.

Further, at least one fastener is preferably made from an adhesive material that secures the cellphone or tablet to the device. In another embodiment, the fastener is comprised of a rubber type material, used as a slip cover for handheld devices to secure the handheld device into place. The fastener prevents the handheld cell phone or tablet from shifting out of place. Moreover, at least one fastener allows the device to attach to the cell phone or tablet in various manners.

The body comprises an exterior body. In one embodiment, the exterior body provides support for the user's hands and fingers. The exterior comprises at least one grip area. At least one grip area provides additional support for the user's hand and fingers. Additionally, at least one grip area ensures the user has a secure grasp on the handheld device. Moreover, at least one grip area is preferably embossed into the exterior body to provide texture for additional grip. Lastly, the exterior body preferably has various forms of indicia.

Moreover, the body is created with various forms of indicia. The indicia can preferably be made with personalization. Further, the indicia can include various colors and patterns. The patterns can include licensed athletic team logos and designer brands. The indicia can also include simple variations including glitter, stripes, polka dots, or other designs as known in the art. The indicia allow users to differentiate between several devices.

The present invention is also comprised of a method of using the device. First, a device is provided comprised of a body, containing a channel and fastener, along with an exterior body comprising a grip area. Then, a user can slide the handheld device into the channel of the device. Next, a user will insert the opposite corner of the device into the opposing channel of the device. Finally, a user will grip the device in their hand for long-lasting comfort while using the handheld device.

Accordingly, the cell phone corner cover device of the present invention is particularly advantageous as it provides users with additional support and comfort while using handheld devices over a period. More specifically, it prevents users from developing health conditions related to strenuous hand and figure use. Furthermore, the device prevents strenuous use of the hand and finger muscles through the comforting gel material and grip area. Additionally, the cell phone corner cover device provides an added layer of protection around the edges of the cell phone or tablet if it were to be dropped onto a hard surface. Lastly, the device enables users to differentiate between several devices through personalized indicia. In this manner, the cell phone corner cover device overcomes the limitations of existing headstones known in the art.

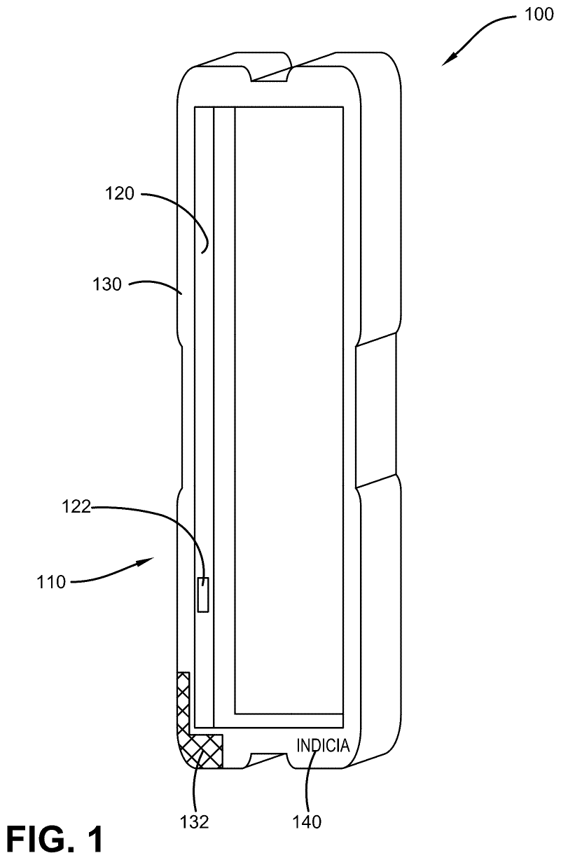

Referring initially to the drawings, FIG. 1 illustrates a perspective view of one potential embodiment of a cell phone corner cover device 100 of the present invention in accordance with the disclosed architecture. The device is comprised of a slip cover body 110 preferably comprised of at least one channel 120 with at least one fastener 122, and an exterior 130 comprising of at least one grip area 132 with at least one indicia 140. The device 100 is designed to provide optimal comfort and support to a user's hand and finger while using a handheld smart device for extended periods of time.

In one embodiment, the slip cover body 110 is made from a gel, rubber, foam, velvet, silicone, water soluble liquids, gel, polymers, surfactants, liquid crystal, and/or colloid material that provides durability and comfort to the user's hands or fingers. Additionally, the body 110 provides bumper protection around the edges of the cell phone or tablet. The body 110 may be any shape and may resemble items, objects, characters, animals, plants, shapes, etc. Further, the body 110 comprises at least one channel 120. The channel 120 receives at least one edge 12 of at least one smart device 10 such as, but not limited to, a cell phone.

In one embodiment, at least one channel 120 is comprised of at least one fastener 122. The fastener 122 is preferably made from an adhesive material that secures the cellphone 10 within the channel 120 and to the device 100. In another embodiment, the fastener 122 is comprised of a magnet to secure the handheld device 10 within the channel 120.

The body 110 is comprised of an exterior surface 130. In one embodiment, the exterior 130 provides support for the user's hands and fingers. In one embodiment, exterior 130 is comprised of at least one grip area 132. The grip area 132 provides additional support for the user's hand and fingers. Additionally, the grip area 132 ensures the user has a secure grasp on the handheld device 10. The grip area 132 may be made of a non-slip, textured rubber material to improve grip.

Moreover, the grip area 132 is preferably embossed into, flush with, or above the exterior body 130 to provide texture for additional grip. In another embodiment, at least one grip area 132 is made from a foam or gel material built into the body 110. In this embodiment, the additional cushion or foam provides additional relief for the user while holding the handheld device 10. The additional grip areas 132 prevent the user from developing long-lasting health conditions related to hand fatigue and finger pain.

Moreover, the body 110 may be comprised of at least one indicia 140. The indicia 140 may include a color, a pattern, a logo, holidays, designer brands, etc. The indicia 140 can also include glitter, stripes, polka dots, or other designs as known in the art. The various forms of indicia 140 allow users to differentiate between several devices. In another embodiment, the user can create their own indicia 140 providing an original design.

The present invention is also comprised of a method of using 200 the device 100. First, a device 100 is provided comprised of a body 110 comprised of at least one channel 120 and at least one fastener 122, with an exterior body 130 comprised of at least one grip area 132 [Step 202.] Then, a user can slide a handheld device 10 into the channel 120 of the device 100 [Step 204]. In one embodiment, the edge 12 of the device 100 can be secured to the channel 120 via at least one fastener 122 of the channel [Step 206]. Then, a user can grip the body 110 and/or grip area 132 while using the handheld device 10 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cell phone corner cover device” and “device” are interchangeable and refer to the cell phone corner cover device 100 of the present invention.

Notwithstanding the foregoing, the cell phone corner cover device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the cell phone corner cover device 100 as shown in the FIGS. are for illustrative purposes only, and that many other sizes and shapes of the cell phone corner cover device 100 are well within the scope of the present disclosure. Although the dimensions of the cell phone corner cover device 100 are important design parameters for user convenience, the cell phone corner cover device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cell phone corner cover device comprising:
a slipcover body component comprised of a channel.

2. The cell phone corner cover device of claim 1, wherein the slipcover body component is comprised of a gel material.

3. The cell phone corner cover device of claim 1, wherein the slipcover body component is comprised of a rubber material.

4. The cell phone corner cover device of claim 1, wherein the slipcover body component is comprised of a foam material.

5. The cell phone corner cover device of claim 1, wherein an exterior surface of the slipcover body component is comprised of a grip area.

6. The cell phone corner cover device of claim 5, wherein the grip area is comprised of a non-slip rubber material.

7. The cell phone corner cover device of claim 6, wherein the non-slip rubber material is comprised of a texture.

8. A cell phone corner cover device comprising:
a slipcover body component comprised of a channel; and
a fastener positioned within the channel.

9. The cell phone corner cover device of claim 8, wherein the slipcover body component is comprised of a gel material.

10. The cell phone corner cover device of claim 8, wherein the slipcover body component is comprised of a rubber material.

11. The cell phone corner cover device of claim 8, wherein the slipcover body component is comprised of a foam material.

12. The cell phone corner cover device of claim 8, wherein an exterior surface of the slipcover body component is comprised of a grip area.

13. The cell phone corner cover device of claim 12, wherein the grip area is comprised of a non-slip rubber material.

14. The cell phone corner cover device of claim 13, wherein the non-slip rubber material is comprised of a texture.

15. The cell phone corner cover device of claim 8, wherein the fastener is comprised of an adhesive fastener.

16. The cell phone corner cover device of claim 8, wherein the fastener is comprised of a magnet fastener.

17. The cell phone corner cover device of claim 8, wherein the slipcover body component is comprised of an indicia.

18. The cell phone corner cover device of claim 17, wherein the indicia is comprised of a color, a pattern, a logo, a brand, a glitter, a stripe, a polka dot, or a design.

19. A method of using a cell phone corner cover device, the method comprising the following steps:
providing a cell phone corner cover device comprised of a body comprised of a channel;
sliding an edge of a handheld device into the channel; and
gripping the body while using the handheld device.

20. The method of using a cell phone corner cover device of claim 19, wherein the handheld device is comprised of a cell phone.
